(19) United States
(12) Patent Application Publication
(10) Pub. No.: US 2008/0221260 A1
(43) Pub. Date: Sep. 11, 2008

(54) Hydrogels with a Low Freezing Point

(75) Inventors: Dieter Hermeling, Bohl-Iggelheim (DE); Bernhard Steinmetz, Rutschenhausen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, Ludwigshafen (DE)

(21) Appl. No.: 11/792,466

(22) PCT Filed: Dec. 16, 2005
(86) PCT No.: PCT/EP05/13554

§ 371 Date: Jun. 6, 2007

(30) Foreign Application Priority Data
Dec. 20, 2004 (DE) 10 2004 062 458.5

(51) Int. Cl. C08L 33/02

(52) U.S. Cl. 524/556

(57) ABSTRACT

The invention relates to hydrogels having a low freezing point, comprising at least one water-absorbing polymer, at least one nonaqueous solvent and water, to a process for their production and to the use of hydrogels in cooling elements.

The present invention relates to hydrogels having a low freezing point, to processes for their production and to the use of hydrogels in coolants.

Further embodiments of the present invention are discernible from the claims, the description and the examples. It will be understood that the hereinbefore identified and the hereinafter still to be more particularly described features of the subject matter of the present invention are utilizable not only in the particular combination indicated but also in other combinations without leaving the realm of the present invention.

Water-absorbing polymers are in particular polymers of (co)polymerized hydrophilic monomers, graft (co)polymers of one or more hydrophilic monomers on a suitable grafting base, crosslinked ethers of cellulose or of starch, crosslinked carboxymethylcellulose, partially crosslinked polyalkylene oxide or natural products swellable in aqueous fluids, such as guar derivatives for example. Such polymers are used as products capable of absorbing aqueous solutions to manufacture diapers, tampons, sanitary napkins and other hygiene articles, as water-retaining agents in market gardening, but also as thickeners for aqueous fluids.

WO-A-03/002623 describes postcrosslinked water-absorbing polymers based on acid-functional monomers neutralized 5 to 60 mol %.

Furthermore, WO 98/10032 discloses a deicing composition comprising a thickener as well as a hygroscopic substance and/or a short-chain aliphatic monohydric alcohol. The thickener stops the active ingredient (glycols, such as ethylene glycol and propylene glycol) running down an inclined plane, for example a windshield, and hence the formation of a water-ice layer.

A further possible application for water-absorbing polymers is their use in coolant compositions, for example in cooling elements. It would be advantageous here if the coolant were shapeable at low temperatures. This would make it possible to optimize the shape of cooling elements to match the shapes of hollow spaces in which they are to be accommodated. At the same time, the coolant should not leak out in the event of the sheath being damaged.

Hydrogels based on crosslinked water-absorbing polymers and water freeze at −2 to −3° C. and lose their flexibility. By adding substances depressing the freezing point of water the freezing point of the hydrogels can be lowered. But the disadvantage to this option is that the additives tend to separate from the solution when the water-absorbing polymer is being mixed with the aqueous solution or from the hydrogel when the hydrogel is stored in the cold.

The present invention has for its object to provide coolant compositions based on crosslinked water-absorbing polymers which are free of the abovementioned disadvantages.

We have found that this object is achieved by novel hydrogels comprising
a) at least one water-absorbing polymer comprising at least one polymerized ethylenically unsaturated monomer bearing acid groups which are from 10 to 50 mol % neutralized and have ions of sodium and/or potassium as a counter-ion, and at least one polymerized crosslinker,
b) at least one nonaqueous solvent, and
c) water,
   wherein the nonaqueous solvent is miscible with water at 23° C. in any proportion, has a melting point of below −20° C., the solubility of sodium chloride in a 50% by weight aqueous solution of the solvent is at least 10 g/100 g, and the hydrogel comprises at least 5% by weight of the solvent, based on the hydrogel.

The degree of neutralization of the acid groups of the at least one polymerized ethylenically unsaturated monomer bearing acid groups is preferably in the range from 15 to 45 mol % and more preferably in the range from 20 to 40 mol %.

The proportion of the neutralized acid groups having ions of sodium and/or potassium as a counter-ion is preferably at least 50 mol %, more preferably at least 75 mol % and most preferably equal to 100 mol %. Sodium counter-ions are particularly preferred.

The melting point of the nonaqueous solvent is preferably below −30° C., more preferably below −40° C. and most preferably below −50° C.

The solubility of sodium chloride in a 50% by weight aqueous solution of the solvent at 23° C. is preferably at least 11 g and more preferably at least 12 g, both based on 100 g of the 50% by weight aqueous solution used.

The solubility can only be determined if no separation of water and nonaqueous solvent occurs; that is, there is no salting out. Otherwise, there will be a liquid phase depleted in nonaqueous solvent and naturally capable of dissolving more sodium chloride. This value therefore is not equal to the solubility in a 50% by weight aqueous solution of the solvent under investigation.

The amount of water-absorbing polymer used is preferably in the range from 0.01% to 5% by weight, more preferably in the range from 0.05% to 4% by weight and most preferably in the range from 0.1% to 3% by weight, based on the hydrogel.

The hydrogel of the present invention comprises preferably at least 10% by weight, more preferably from 10% to 85% by weight, even more preferably from 30% to 65% by weight and most preferably from 40% to 55% by weight, based on the hydrogel, of the nonaqueous solvent.

Preferred nonaqueous solvents are methanol, 2-methoxyethanol, dimethylformamide and 1,2-propylene glycol. The solvents can be used alone or as a mixture, for example methanol, 1,2-propylene glycol or methanol/1,2-propylene glycol.

The hydrogel of the present invention further comprises preferably at least 10% by weight of water, more preferably in the range from 10% to 85% by weight, even more preferably in the range from 30% to 65% by weight and most preferably in the range from 40% to 55% by weight, based on the hydrogel.

The sum total of components a) to c) is not more than 100% by weight.

The hydrogels of the present invention are obtained by mixing components a) to c) with or without addition of further components. The order of mixing is freely chooseable and it is preferable to premix components b) and c).

The present invention further provides hydrogels having a freezing point of below −10° C., preferably below −20° C. and most preferably below −30° C.

The hydrogels of the present invention are useful as coolants in cooling elements.

The present invention further provides cooling elements comprising

i) at least one hydrogel having a freezing point of below −10° C., and
ii) at least one flexible outer sheath.

The freezing point of the hydrogels used is preferably below −20° C. and most preferably below −30° C.

Examples of useful materials for the outer sheath are polyethylene, polypropylene and polyvinyl chloride.

The water-absorbing polymers to be used in the process of the present invention are not subject to any restriction. The production of water-absorbing polymers is described for example in the monograph “Modern Superabsorbent Polymer Technology”, F. L. Buchholz and A. T. Graham, Wiley-VCH, 1998, or in Ullmann's Encyclopedia of Industrial Chemistry, 6th edition, volume 35, pages 73 to 93.

To produce water-absorbing polymers, ethylenically unsaturated monomers bearing acid groups are reacted in the presence of crosslinkers to form a base polymer. The reaction is preferably carried out in a kneader as described for example in WO-A-01/38402 or on a belt reactor as described for example in EP-A-0 955 086. The base polymers may additionally be surface postcrosslinked.

The water-absorbing polymers to be used in the process of the present invention are in particular polymers of crosslinked (co)polymerized hydrophilic monomers, polyaspartic acid, graft (co)polymers of one or more hydrophilic monomers on a suitable grafting base, crosslinked cellulose ethers or crosslinked starch ethers. Preferably the polymer to be crosslinked is a polymer which comprises structural units which are derived from acrylic acid or acrylic esters or which were obtained by graft copolymerization of acrylic acid or acrylic esters onto a water-soluble polymeric matrix. These hydrogels are known to one skilled in the art and are described for example in U.S. Pat. No. 4,286,082, DE-C 27 06 135, U.S. Pat. No. 4,340,706, DE-C 37 13 601, DE-C 28 40 010, DE-A 43 44 548, DE-A 40 20 780, DE-A 40 15 085, DE-A 39 17 846, DE-A 38 07 289, DE-A 35 33 337, DE-A 35 03 458, DE-A 42 44 548, DE-A 42 19 607, DE-A 40 21 847, DE-A 38 31 261, DE-A 35 11 086, DE-A 31 18 172, DE-A 30 28 043, DE-A 44 18 881, EP-A-0 801 483, EP-A-0 455 985, EP-A-0 467 073, EP-A-0 312 952, EP-A-0 205 874, EP-A-0 499 774, DE-A 26 12 846, DE-A 40 20 780, EP-A-0 205 674, U.S. Pat. No. 5,145,906, EP-A-0 530 438, EP-A-0 670 073, U.S. Pat. No. 4,057,521, U.S. Pat. No. 4,062,817, U.S. Pat. No. 4,525,527, U.S. Pat. No. 4,295,987, U.S. Pat. No. 5,011,892, U.S. Pat. No. 4,076,663 or U.S. Pat. No. 4,931,497.

Examples of hydrophilic monomers useful for preparing these water-absorbing polymers are polymerization-capable acids, such as acrylic acid, methacrylic acid, vinylsulfonic acid, vinylphosphonic acid, maleic acid including its anhydride, fumaric acid, itaconic acid, 2-acrylamido-2-methylpropanesulfonic acid, 2-acrylamido-2-methylpropanephosphonic acid and also their amides, hydroxyalkyl esters and amino- or ammonio-containing esters and amides and also the alkali metal and/or ammonium salts of the acid-functional monomers. Also suitable are water-soluble N-vinylamides such as N-vinylformamide or else diallyldimethylammonium chloride. Preferred hydrophilic monomers are compounds of the general formula I

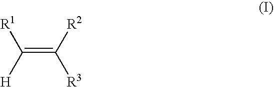

where
R¹ is hydrogen, methyl, ethyl or carboxyl,
R² is —COOR⁴, hydroxysulfonyl or phosphonyl, a C₁-C₄-alkanol-esterified phosphonyl group or a group of the formula II

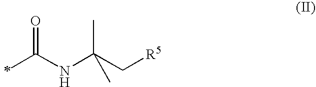

R³ is hydrogen, methyl or ethyl,
R⁴ is hydrogen, C₁-C₄-aminoalkyl, C₁-C₄-hydroxyalkyl, alkali metal ion or ammonium ion, and
R⁵ is a sulfonyl group, a phosphonyl group or a carboxyl group or an alkali metal or ammonium salt of each of these.

Examples of C₁-C₄-alkanols are methanol, ethanol, n-propanol, isopropanol or n-butanol.

Particularly preferred hydrophilic monomers are acrylic acid and methacrylic acid and also their sodium and potassium salts.

Suitable grafting bases for water-absorbing polymers obtainable via graft copolymerization of olefinically unsaturated acids or their alkali metal or ammonium salts may be of natural or synthetic origin. Examples are starch, cellulose or cellulose derivatives and also other polysaccharides and oligosaccharides, polyalkylene oxides, in particular polyethylene oxides and polypropylene oxides, and also hydrophilic polyesters.

Suitable polyalkylene oxides have for example the formula III

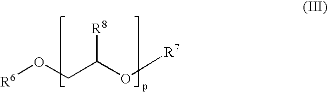

where
R⁶ and R⁷ are each independently hydrogen, alkyl, alkenyl or aryl,
R⁸ is hydrogen or methyl, and
p is an integer from 1 to 500.

R⁶ and R⁷ are each preferably hydrogen, C₁-C₄-alkyl, C₂-C₆-alkenyl or phenyl.

Preferred water-absorbing polymers are in particular polyacrylates, polymethacrylates and also the graft polymers described in U.S. Pat. No. 4,931,497, U.S. Pat. No. 5,011,892 and U.S. Pat. No. 5,041,496.

The water-absorbing polymers are preferably in crosslinked form; that is, they comprise compounds having at least two double bonds which have been interpolymerized into the polymer network. Suitable crosslinkers are in particular N,N′-methylenebis-acrylamide and N,N′-methylenebismethacrylamide, esters of unsaturated mono- or polycarboxylic acids of polyols, such as diacrylate or triacrylate, examples being the diacrylates and methacrylates of butanediol and ethylene and also trimethylolpropane triacrylate and allyl compounds such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described for example in EP-A-0 343 427. The process of the present invention may also utilize dimethacrylates of polyethylene glycols, the polyethylene glycol used having a molecular weight between 300 and 1000. Di- and/or trimethacrylates of multiply ethoxylated trimethylolpropane or trimethylolethane are also useful. Trimethacrylates of 5 tuply to 30 tuply ethoxylated trimethylolpropane or trimethylolethane are particularly useful. Trimethacrylates of 10 tuply to 20 tuply ethoxylated trimethylolpropane or trimethylolethane are even more useful. The triacrylates of 13 tuply to 18 tuply ethoxylated trimethylolpropane or trimethylolethane are most useful.

The process of the present invention may further utilize hydrogels prepared using polyallyl ethers as crosslinkers and by acidic homopolymerization of acrylic acid. Useful crosslinkers include pentaerythritol triallyl ether, pentaerythritol tetraallyl ether, polyethylene glycol diallyl ether, monoethylene glycol diallyl ether, glycerol diallyl ether, glycerol triallyl ether, polyallyl ethers based on sorbitol and also ethoxylated versions thereof. Crosslinkers which are very particularly preferred are the di- or tri(meth)acrylated multiply ethoxylated and/or propoxylated glycerols as described for example in prior German patent application 103 19 462.2. Di- and/or tri(meth)acrylates of 3 to 10 tuply ethoxylated glycerol are particularly advantageous. Di- or tri(meth)acrylates of 1 to 5 tuply ethoxylated and/or propoxylated glycerol are very particularly preferred. The tri(meth)acrylates of 3 to 5 tuply ethoxylated or propoxylated glycerol are most preferred.

The preferred methods of making the base polymer which can be used in the process of the present invention are described in “Modern Superabsorbent Polymer Technology”, F. L. Buchholz and A. T. Graham, Wiley-VCH, 1998, pages 77 to 84. Particular preference is given to base polymers which are produced in a kneader as described for example in WO A 01/38402 or on a belt reactor as described for example in EP-A-0 955 086.

The water-absorbing polymer is preferably a polymeric acrylic acid or a polyacrylate. This water-absorbing polymer may be prepared according to a literature method. Preference is given to polymers which comprise crosslinking comonomers in amounts from 0.01 to 10 mol % and preferably from 0.2 to 1 mol %, but most preference is given to polymers which were obtained by free-radical polymerization using a polyfunctional ethylenically unsaturated free-radical crosslinker which additionally bears at least one free hydroxyl group (such as for example pentaerythritol triallyl ether or trimethylolpropane diallyl ether).

The water-absorbing polymers are obtainable by conventional polymerization processes. Preference is given to addition polymerization in aqueous solution by the process known as gel polymerization. In this process for example from 15 to 50% by weight aqueous solutions of one or more hydrophilic monomers and if appropriate of a suitable grafting base are polymerized in the presence of a free-radical initiator, preferably without mechanical mixing, by utilizing the Trommsdorff-Norrish effect (Makromol. Chem. 1, 169 (1947)). The addition polymerization reaction may be carried out in the temperature range between 0 and 150° C. and preferably between 10 and 100° C., not only at atmospheric pressure but also at elevated or reduced pressure. As customary, the addition polymerization may also be carried out in a protective gas atmosphere, preferably under nitrogen. The addition polymerization may be initiated using high-energy electromagnetic radiation or the customary chemical addition polymerization initiators, for example organic peroxides, such as benzoyl peroxide, tert-butyl hydroperoxide, methyl ethyl ketone peroxide, cumene hydroperoxide, azo compounds such as azodiisobutyronitrile and also inorganic peroxo compounds such as (NH₄)₂S₂O₈, K₂S₂O₈, Na₂S₂O₈ or H₂O₂. They may if appropriate be used in combination with reducing agents such as sodium bisulfite and iron(II) sulfate or redox systems where the reducing component comprises an aliphatic and aromatic sulfinic acid, such as benzenesulfinic acid and toluenesulfinic acid or derivatives thereof, such as Mannich adducts of sulfinic acids, aldehydes and amino compounds. The performance properties of the polymers may be further improved by postheating the polymer gels for a number of hours in the temperature range from 50 to 130° C. and preferably from 70 to 100° C.

The gels obtained are neutralized to an extent in the range from 10 to 60 mol %, preferably in the range from 20 to 55 mol % and more preferably in the range from 25 to 50 mol %, based on monomer used. Customary neutralizing agents can be used, preferably alkali metal hydroxides or oxides, but more preferably sodium hydroxide, sodium carbonate and sodium bicarbonate.

When the degree of neutralization of the water-absorbing polymer is higher, the hydrogels comprising at least one nonaqueous solvent and water will separate at low temperatures. At a lower degree of neutralization for the water-absorbing polymer, its Free Swell Capacity decreases.

Neutralization is customarily effected by admixing the neutralizing agent as an aqueous solution or else preferably as a solid. For this purpose, the gel is mechanically comminuted, by means of a meat grinder for example, and the neutralizing agent is sprayed on, scattered over or poured on and then carefully mixed in. To effect homogenization, the resultant gel mass may be passed through the meat grinder again a number of times. The neutralized gel mass is then dried using a belt or drum dryer until the residual moisture content is preferably below 10% by weight and especially below 5% by weight. The dried hydrogel is subsequently ground and sieved, the customary grinding apparatus being roll mills, pin mills or swing mills. The particle size of the sieved hydrogel is customarily below 1000 μm, frequently below 700 μm and preferably below 500 μm.

Postcrosslinking is customarily carried out by spraying a solution of the surface postcrosslinker onto the hydrogel or onto the dry base-polymeric powder. Following spraying, the polymer powder is thermally dried, and the crosslinking reaction can take place not only before but also during drying.

Preference is given to spray application of a solution of the crosslinker in reaction mixers or mixing and drying systems such as for example Lödige® mixers, BEPEX® mixers, NAUTA® mixers, SCHUGGI® mixers, NARA® dryers or PROCESSALL®. Moreover, fluidized bed dryers can also be used.

Drying can take place in the mixer itself, by heating the outer casing or by blowing hot air into the mixer. It is similarly possible to use a downstream dryer such as a tray dryer, a rotary tube oven or a heatable screw. But it is also possible, for example, to use an azeotropic distillation as a drying process.

Preferred drying temperatures are in the range from 50 to 250° C., preferably in the range from 50 to 200° C. and more preferably in the range from 50 to 150° C. The preferred residence time at this temperature in the reaction mixer or dryer is below 30 minutes and preferably below 10 minutes.

The crosslinker is preferably dissolved in non-self-reactive solvents, preferably in lower alcohols, such as for example methanol, ethanol, propanediol, ethylene glycol, most preferably in aqueous solutions of such suitable alcohols, in which case the alcohol content of the solution is in the range from 10% to 90% by weight and more preferably in the range from 40% to 60% by weight.

The crosslinker is used in an amount from 0.01% to 1% by weight, based on the polymer used, and the crosslinker solution itself in an amount from 1% to 20% by weight and preferably from 5% to 15% by weight, based on the polymer used.

The hydrogels of the present invention have a low freezing point and do not separate in prolonged storage. This is achieved through the optimal matching between the ionic strength of the counter-ions and the degree of neutralization. If the water-absorbing polymer is too hydrophobic, water will separate as a liquid, slowly solidifying phase at low temperatures; if the water-absorbing polymer is too hydrophilic, the diol will separate as a liquid phase at low temperatures.

The hydrogels of the present invention may in particular also utilize commercially available water-absorbing polymers as used for adult incontinence for example. Hence the water-absorbing polymers for the hydrogels of the present invention are inexpensively available.

### Methods:

Measurements should be carried out unless otherwise stated at an ambient temperature of 23±2° C. and a relative humidity of 50±10%. The swellable hydrogel-forming polymer is thoroughly mixed through before measurement.

### Free Swell Capacity (FSC)

Free swell capacity is determined according to EDANA (European Disposables and Nonwovens Association) recommended test method No. 440.2-02 “Free swell capacity”.

### Centrifuge Retention Capacity (CRC)

Centrifuge retention capacity is determined according to EDANA (European Disposables and Nonwovens Association) recommended test method No. 441.2-02 “Centrifuge retention capacity”.

### EXAMPLES

### Example 1

A Dewar vessel was charged with 248 g of water, 91 g of acrylic acid, 0.5 g of pentaerythritol triallyl ether and 0.036 g of Kymene® 736 (aqueous reaction product of a polymeric amine with epichlorohydrin). The mixture was inertized for 30 minutes by bubbling nitrogen through it. The reaction was then initiated at about 23° C. by addition of 0.01 g of 35% by weight hydrogen peroxide, 1.0 g of 1% by weight aqueous ascorbic acid and also 9.1 g of 10% by weight aqueous sodium hydrogensulfite. The gel eventually obtained was neutralized with 73.8 g of 50% by weight aqueous sodium hydroxide solution in a meat grinder. The neutralized gel was dried in a circulating air drying cabinet at 180° C. for about 3 hours. It was then ground and classified to 100-850 μm by sieving off over- and undersize.

In a Waring blender, the base polymer was sprayed with 4% by weight of a postcrosslinker solution, based on base polymer, and the polymer was postcrosslinked at 120° C. product temperature for 60 minutes. The polymer obtained was subsequently passed through an 850 μm sieve to remove any lumps present.

The postcrosslinking solution had the following composition: 4.8% by weight of ethylene glycol diglycidyl ether, 47.6% by weight of propylene glycol and 47.6% by weight of water.

The postcrosslinked, water-absorbing polymer A had the following properties:

### FSC: 47.7 g/g

### CRC: 29.7 g/g

### Example 2

A Lödige plowshare kneader 10 l in capacity was charged with 1189 g of water and 618 g of acrylic acid. With stirring, 191 g of 50% by weight aqueous sodium hydroxide solution and also 1.84 g of polyethylene glycol diacrylate (diacrylate of a polyethylene glycol having an average molecular weight of 400 g/mol) and 0.46 g of sorbitan monooleate were meteringly added in succession and inertized for 30 minutes by bubbling nitrogen through. The reaction was then initiated at about 23° C. by addition of 0.4 g of 3% by weight hydrogen peroxide, 6.2 g of 0.5% by weight of aqueous ascorbic acid and also 4.1 g of 15% by weight aqueous sodium peroxodisulfate. After initiation, the temperature of the heating jacket was closed loop controlled to the reaction temperature in the reactor. The polymerization in the kneader was carried out with stirring and thorough mixing through. The crumbly gel eventually obtained was then dried at 180° C. in a circulating air drying cabinet for about 3 hours. It was subsequently ground and sieved to a size of less than 100 μm.

In a Waring blender, the base polymer was sprayed with 5% by weight of a postcrosslinker solution, based on base polymer, and the polymer was postcrosslinked at 150 to 170° C. product temperature for 60 minutes. The polymer obtained was subsequently passed through a 100 μm sieve to remove any lumps present. The end product was phlegmatized by addition of 0.35% by weight, based on the polymer, of polyethylene glycol having an average molecular weight of 300 g/mol.

The postcrosslinking solution had the following composition: 2% by weight of ethylene glycol diglycidyl ether, 30% by weight of propylene glycol and 68% by weight of water.

The postcrosslinked, water-absorbing polymer B had the following properties:

### FSC: 28.0 g/g

### CRC: 20.0 g/g

### Example 3

200 g of demineralized water and 200 g of 1,2-propanediol were premixed. 2 g of a 30 mol % neutralized, crosslinked polyacrylate (polymer B) were admixed with stirring.

A portion of the hydrogel was filled into a large test tube and cooled with acetone/dry ice from the outside. The hydrogel completely solidified at −39° C. The rest of the hydrogel was filled into a sealable bottle and stored at 23° C. There was no phase separation to be seen after one week.

### Example 4

### Comparative Example

200 g of demineralized water and 200 g of 1,2-propanediol were premixed. 2 g of a 75 mol % neutralized, crosslinked polyacrylate (polymer A) were admixed with stirring.

A portion of the hydrogel was filled into a large test tube and cooled with acetone/dry ice from the outside. The hydrogel completely solidified at −39° C.

The rest of the hydrogel was filled into a sealable bottle and stored at 23° C. There was a sign of phase separation after one week. The hydrogel had settled out. A liquid phase (1,2-propanediol) was demonstrated above the hydrogel.

### Example 5

200 g of demineralized water and 200 g of methanol were premixed. 2 g of a 30 mol % neutralized, crosslinked polyacrylate (polymer B) were admixed with stirring.

A portion of the hydrogel was filled into a large test tube and cooled with acetone/dry ice from the outside. The freezing point of the hydrogel was below −50° C.

The rest of the hydrogel was filled into a sealable bottle and stored at 23° C. There was no phase separation to be seen after one week.

### Example 6

200 g of demineralized water and 200 g of 2-methoxyethanol were premixed. 2 g of a 30 mol % neutralized, crosslinked polyacrylate (polymer B) were admixed with stirring.

A portion of the hydrogel was filled into a large test tube and cooled with acetone/dry ice from the outside. The hydrogel completely solidified at −42° C.

The rest of the hydrogel was filled into a sealable bottle and stored at 23° C. There was no phase separation to be seen after one week.

### Example 7

200 g of demineralized water and 200 g of dimethylformamide were premixed. 2 g of a 30 mol % neutralized, crosslinked polyacrylate (polymer B) were admixed with stirring.

A portion of the hydrogel was filled into a large test tube and cooled with acetone/dry ice from the outside. The hydrogel completely solidified at −51° C.

The rest of the hydrogel was filled into a sealable bottle and stored at 23° C. There was no phase separation to be seen after one week.

### Example 8

### Comparative Example

200 g of demineralized water and 200 g of 1-propanol were premixed. 2 g of a 30 mol % neutralized, crosslinked polyacrylate (polymer B) were admixed with stirring.

A portion of the hydrogel was filled into a large test tube and cooled with acetone/dry ice from the outside. The hydrogel completely solidified at −15° C.

The rest of the hydrogel was filled into a sealable bottle and stored at 23° C. There was a sign of phase separation after three hours. The hydrogel had settled out. A liquid phase (1-propanol) was demonstrated above the hydrogel.

### Example 9

### Comparative Example

200 g of demineralized water and 200 g of ethanol were premixed. 2 g of a 30 mol % neutralized, crosslinked polyacrylate (polymer B) were mixed with stirring. There was a sign of phase separation immediately after mixing. The hydrogel had settled out. A liquid phase (ethanol) was demonstrated above the hydrogel.

### Example 10

The solubility of sodium chloride in 50% by weight aqueous solutions of different solvents was determined.

10 g of nonaqueous solvent and 10 g of water were mixed. The mixture was admixed with 5 g of sodium chloride and stirred at 23° C. for 17 hours. The mixture was then filtered and the filter residue was washed with diethyl ether, dried and weighed.

The back-weighed sodium chloride quantity was used to determine the dissolved fraction and to calculate the solubility.

| | | | Solubility of |
|---|---|---|---|
| | | | sodium chloride |
| | Miscibility | Melting | in 50% by |
| | with water | point | weight solution |
| 2-Methoxyethanol | in any | −85° C. | 15.5 g/100 g |
| | proportion | | |
| Dimethylformamide | in any | −61° C. | 13.6 g/100 g |
| | proportion | | |
| Ethanol | in any | −117° C. | 9.8 g/100 g |
| | proportion | | |
| 1,2-Propanol | in any | −60° C. | 15.59/100 g |
| | proportion | | |

The solubility of sodium chloride in a 50% by weight aqueous solution of 1-propanol could not be determined. 1-Propanol was salted out during the dissolving.

1. A hydrogel comprising
a) at least one water-absorbing polymer comprising at least one polymerized ethylenically unsaturated monomer bearing acid groups which are from 10 to 50 mol % neutralized and have ions of sodium and/or potassium as a counter-ion, and at least one polymerized crosslinker,
b) at least one nonaqueous solvent, and
c) water,
wherein the nonaqueous solvent is miscible with water at 23° C. in any proportion, has a melting point of below −20° C., a solubility of sodium chloride in a 50% by weight aqueous solution of the solvent at 23° C. is at least 10 g/100 g, and the hydrogel comprises at least 5% by weight of the solvent, based on the hydrogel.

2. The hydrogel according to claim 1 wherein from 20 to 45 mol % of the acid groups have ions of sodium and/or potassium as a counter-ion.

3. The hydrogel according to claim 1 wherein the counter-ions are sodium ions.

4. The hydrogel according to claim 1 wherein the water-absorbing polymer comprises from 0.01% to 10% by weight of the polymerized crosslinker.

5. The hydrogel according to claim 1 wherein the hydrogel comprises from 0.01% to 5% by weight of the water-absorbing polymer.

6. The hydrogel according to claim 1 wherein the solvent content of the hydrogel is in the range from 10% to 85% by weight.

7. The hydrogel according to claim 1 wherein the solvent is methanol, 2-methoxyethanol, dimethylformamide, and/or propylene glycol.

8. The hydrogel according to claim 1 wherein the water content of the hydrogel is in the range from 10% to 85% by weight.

9. A process for producing a hydrogel, which comprises mixing at least one water-absorbing polymer according to claim 1, at least 5% by weight, based on the hydrogel, of a nonaqueous solvent wherein the nonaqueous solvent is miscible with water at 23° C. in any proportion, has a melting point of below −20° C., a solubility of sodium chloride in a 50% by weight aqueous solution of the solvent at 23° C. is at least 10 g/100 g, and water.

10. The process according to claim 9 wherein the solvent and the water are premixed.

11. A cooling element comprising
i) at least one hydrogel having a freezing point of below −10° C., and
ii) at least one flexible outer sheath.
